(19) United States
(12) Patent Application Publication
(10) Pub. No.: US 2025/0041900 A1
(43) Pub. Date: Feb. 6, 2025

(54) ULTRASONIC TRANSDUCER AND METHOD FOR MANUFACTURING THE SAME

(71) Applicant: Suncall Corporation, Kyoto-shi, Kyoto (JP)

(72) Inventor: Satoru TAKASUGI, Kyoto-shi, Kyoto (JP)

(21) Appl. No.: 18/713,322

(22) PCT Filed: Nov. 25, 2021
(86) PCT No.: PCT/JP2021/043197

§ 371 Date: May 24, 2024

(51) Int. Cl. B06B 3/00; B06B 1/06

(52) U.S. Cl. CPC B06B 3/00; B06B 1/0622

(57) ABSTRACT

An ultrasonic transducer having a rigid supporting plate having first and second surfaces on one side and the other side in a thickness direction; a plurality of cavity portions opened to the first surface; a plurality of waveguides having first end portions on one side that are opened to bottom surfaces of the cavity portions and second end portions on the other side that are opened to the second surface; a flexible resin film fixed to the first surface of the supporting plate to cover the cavity portions; the cavity portions fixed to the flexible film resin film overlapped by piezoelectric elements in their center regions and overlapped by the first surface of the supporting plate in a plan view in their peripheral regions; and an air passage capable of introducing outside air into a plurality of sound passages formed by the pluralities of cavity portions and waveguides.

### FIELD OF THE INVENTION

The present invention relates to an ultrasonic transducer in which a plurality of piezoelectric elements are arranged in parallel and which can be suitably used as a phased array sensor and a method for manufacturing the same.

### BACKGROUND ART

An ultrasonic transducer in which a plurality of piezoelectric elements functioning as vibrating bodies are arranged in parallel can control an azimuth of sonic wave emitted by the plurality of piezoelectric elements by controlling phases of voltages to be applied to the plurality of piezoelectric elements so that the ultrasonic transducer can be suitably used as a phased array sensor for detecting a shape of an object or detecting a presence or absence of an object over a wide range.

In a conventional ultrasonic transducer, a resonance frequency of the piezoelectric element has been set in accordance with a driving frequency. In a case where there is a dispersion in the resonance frequency among the plurality of piezoelectric elements, a dispersion in the phases of the vibrations is generated among the piezoelectric elements even if phases of voltages having a predetermined driving frequency that are applied to the plurality of piezoelectric elements are controlled. The dispersion in the phases of the vibrations makes it difficult to precisely control directivity of the sonic wave respectively emitted by the plurality of piezoelectric elements.

Specifically, in order to stably operate the ultrasonic transducer as the phased array sensor, it is needed to uniformize resonance frequencies of the plurality of piezoelectric elements provided in the ultrasonic transducer. However, uniformizing resonance frequencies of the plurality of piezoelectric elements is extremely difficult due to various reasons caused by a material and a manufacturing process.

In this respect, the applicant of the present application filed a patent application regarding an ultrasonic transducer capable of securing an enough vibrational amplitude of the piezoelectric element even in a case where a frequency (driving frequency) of a driving voltage applied to the piezoelectric element functioning as the vibrating body is set to be lower than the resonance frequency of the piezoelectric element, and the patent application has been patented (see Patent Literature 1 shown below).

The ultrasonic transducer disclosed by the Patent Literature 1 is configured to include a rigid substrate with a plurality of opening penetrating through top and bottom surfaces, a flexible resin film fixed to the top surface of the substrate so as to cover the plurality of openings and a plurality of piezoelectric elements fixed to a top surface of the flexible resin film so as to overlap with the plurality of opening parts, respectively, in a plan view, and thereby effectively securing an enough vibrational amplitude of the piezoelectric element even in a case where the driving frequency is set to be lower than the resonance frequency of the piezoelectric element.

A detection of a position of an object (a distance to the object and a direction of the object) is performed by applying burst waveform voltages, which are phase-controlled, of a predetermined frequency to the plurality of piezoelectric elements so as to make the plurality of piezoelectric elements emit sonic waves toward the object, receiving sonic waves that are reflected by and returned from the object, and detecting a time length from an emission of the sonic wave until a reception of the reflected wave (the reception of the reflected wave can be performed by the ultrasonic transducer that has emitted the sonic wave, and can be also performed by another reception exclusive ultrasonic transducer).

Therefore, if foreign matters such as dust and waterdrop are adhered to an inside of the opening of the substrate forming waveguide of the sonic wave that the vibrating body, which are formed by the piezoelectric element and the flexible resin film, generates, it is not possible to stably emit and/or receive sonic waves, and, as a result, the position of the object cannot be detected accurately.

In particular, in a case where the ultrasonic transducer is set outdoor, a possibility that foreign matters such as dust and waterdrop due to rain and snow or the like is increased.

### PRIOR ART DOCUMENT

### Patent Literature

Patent Literature 1: Japanese Patent No. 6776481

### SUMMARY OF THE INVENTION

The present invention has been made in consideration of the conventional technology, and it is an object to provide an ultrasonic transducer capable of effectively preventing or reducing foreign matters from being adhered to a passage for emitted ultrasonic wave and/or received ultrasonic wave, and also provide a manufacturing method of the ultrasonic transducer.

In order to achieve the object, a first aspect of the present invention provides an ultrasonic transducer including a rigid supporting plate having first and second surfaces on one side and the other side in a thickness direction, respectively, the supporting plate being provided with a plurality of cavity portions opened to the first surface, and a plurality of waveguides having first end portions on one side that are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides.

The ultrasonic transducer according to the first aspect of the present invention makes it possible to effectively preventing or reducing foreign matters from being adhered to a sound passage of sonic wave that the transducer emits and/or receive by virtue of the outside air introduced into the sound passage through the air passage, thereby keeping a good transmission characteristic of the sonic wave.

In the first aspect, the air passage preferably may have an air outlet port opened to an inside wall surface of the supporting plate that forms the sound passage and facing a plate-surface direction of the supporting plate.

In the first aspect, the air passage preferably may have a single air inlet port on one end side that is opened to an outer surface of the supporting plate, and a plurality of the outlet ports on the other end side that are opened to the plurality of sound passages, respectively.

In a first configuration of the first aspect, the supporting plate is formed with a groove opened to the first surface, and the flexible resin film that is configured to cover the groove as well as the plurality of cavity portions. In this configuration, the air passage is formed by the groove formed in the supporting plate and the flexible resin film.

In a second configuration of the first aspect, the supporting plate includes a first plate body formed with a plurality of through holes having the opening widths same as those of the plurality of cavity portions and a second plate body formed with a plurality of through holes having the opening widths same as those of the plurality of waveguides, and is formed by the first and second plate bodies fixed to each other in a state of being laminated in the thickness direction.

In this configuration, at least one of the first and second plate bodies is formed with a groove opened to an abutted surface, and the air passage is formed by the groove and an abutted surface of the other one of the first and second plate bodies that covers the groove.

In order to achieve the object, a second aspect of the present invention provides an ultrasonic transducer including a rigid supporting plate having first and second surfaces on one side and the other side in a thickness direction, respectively, the supporting plate being provided with a plurality of waveguides penetrating between the first and second surfaces; a flexible resin film that is fixed to the first surface of the supporting plate so as to cover the plurality of waveguides; the same number of piezoelectric elements as the waveguides that are fixed to the flexible resin film so that their center regions overlap with the corresponding waveguides and their peripheral regions overlap with the first surface of the supporting plate in a plan view; and an air passage capable of introducing outside air into the plurality of waveguides.

The ultrasonic transducer according to the second aspect of the present invention makes it possible to effectively preventing or reducing foreign matters from being adhered to a sound passage of sonic wave that the transducer emits and/or receive by virtue of the outside air introduced into the sound passage through the air passage, thereby keeping a good transmission characteristic of the sonic wave.

In the second aspect, the air passage preferably may have an air outlet port opened to an inside wall surface of the supporting plate that forms the waveguide and facing a plate-surface direction of the supporting plate.

In the second aspect, the air passage preferably may have a single air inlet port on one end side that is opened to an outer surface of the supporting plate, and a plurality of the outlet ports on the other end side that are opened to the plurality of waveguides, respectively

In a first configuration of the first aspect, the supporting plate is formed with a groove opened to the first surface, and the flexible resin film is configured to cover the groove as well as the plurality of waveguides. In this configuration, the air passage is formed by the groove formed in the supporting plate and the flexible resin film

Furthermore, the present invention provides a manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method including a step of forming a first plate body by preparing a first rigid plate member having a thickness, which is a distance between a first surface on one side and a second surface on the other side in a thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the first surface of the first rigid plate member, the groove having one side opened to an outer side wall of the first rigid plate member and the other side divided into a plurality of branches that are opened to the plurality of through holes, respectively, in a state of opened to the first surface; a step of forming a second plate body by preparing a second rigid plate member having a thickness, which is a distance between a first surface on one side and a second surface on the other side in a thickness direction, same as the depth of the plurality of waveguides, and forming, by etching the second rigid plate member, a plurality of through holes having opening widths same as those of the plurality of waveguides; a step of forming the supporting plate by adhering the second surface of the first plate body to the first surface of the second plate body with an adhesive; a flexible resin film fixing step of fixing the flexible resin film to the supporting plate by an adhesive or by thermocompression bonding so as to cover the plurality of through holes and the groove that are formed in the first plate body; and a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view, wherein the groove and the flexible resin film form the air passage.

Furthermore, the present invention provides a manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method including a step of forming the supporting plate by preparing a rigid plate member having a thickness, which is a distance between a first surface on one side and a second surface on the other side in the thickness direction, same as the total depth of the plurality of cavity portions and the plurality of waveguides, and forming, by half-etching the first rigid plate member, the plurality of cavity portions and a groove having one side opened to an outer side wall of the rigid plate member and the other side divided into a plurality of branches that are opened to the plurality of cavity portions, respectively, in a state of opened to the first surface, and also forming the plurality of waveguides by etching the first surface or the second surface of the rigid plate member; a flexible resin film fixing step of fixing the flexible resin film to the supporting plate by an adhesive or by thermocompression bonding so as to cover the plurality of cavity portions and the groove; and a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view, wherein the groove and the flexible resin film form the air passage.

Furthermore, the present invention provides a manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method including a step of forming a first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the second surface of the first rigid plate member, the groove having one side opened to an outer side wall of the first rigid plate member and the other side divided into a plurality of branches that are opened to the plurality of through holes, respectively, in a state of opened to the second surface; a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides; a step of forming the supporting plate by adhering the second surface of the first plate body to the first surface of the second plate body with an adhesive; a flexible resin film fixing step of fixing the flexible resin film to the supporting plate by an adhesive or by thermocompression bonding so as to cover the plurality of through holes formed in the first plate body; and a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view, wherein the groove and the first surface of the second plate body form the air passage.

Furthermore, the present invention provides a manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method including a step of forming the first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces; a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides, and also forming, by half etching the first surface of the second rigid plate member, a groove having one side opened to an outer side wall of the second rigid plate member and the other side divided into a plurality of branches, in a state of opened to the first surface; a step of forming the supporting plate by adhering the second surface of the first plate body to the first surface of the second plate body with an adhesive; a flexible resin film fixing step of fixing the flexible resin film to the supporting plate by an adhesive or by thermocompression bonding so as to cover the plurality of through holes formed in the first plate body; and a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view, wherein the groove and the second surface of the first plate body form the air passage.

Furthermore, the present invention provides a manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method including a step of forming a first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the second surface of the first rigid plate member, a first groove having one side opened to an outer side wall of the first rigid plate member and the other side divided into a plurality of branches that are opened to the plurality of through holes, respectively, in a state of opened to the second surface; a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides, and also forming, by half etching the first surface of the second rigid plate member, a second groove having one side opened to an outer side wall of the second rigid plate member and the other side divided into a plurality of branches, in a state of opened to the first surface; a step of forming the supporting plate by adhering the second surface of the first plate body to the first surface of the second plate body with an adhesive; a flexible resin film fixing step of fixing the flexible resin film to the supporting plate by an adhesive or by thermocompression bonding so as to cover the plurality of through holes formed in the first plate body; and a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view, wherein the first and second grooves that are abutted against each other when the second surface of the first plate body is fixed to the first surface of the second plate body form the air passage.

Furthermore, the present invention provides a manufacturing method of an ultrasonic transducer that includes a rigid supporting plate having first and second surfaces on one side and the other side in a thickness direction, respectively and provided with a plurality of waveguides penetrating between the first and second surfaces; a flexible resin film that is fixed to the first surface of the supporting plate so as to cover the plurality of waveguides; the same number of piezoelectric elements as the waveguides that are fixed to the flexible resin film so that their center regions overlap with the corresponding waveguides and their peripheral regions overlap with the first surface of the supporting plate in a plan view; and an air passage capable of introducing outside air into the plurality waveguides, the manufacturing method including a supporting plate forming step of forming the supporting plate by preparing a rigid plate member having a thickness, which is a distance between a first surface on one side and a second surface on the other side in the thickness direction, same as the depth of the plurality of waveguides, and forming the plurality of waveguides in the rigid plate member by etching and also forming the groove on the first surface of the rigid plate member by half-etching, the groove having one side opened to an outer side wall of the rigid plate member and the other side divided into a plurality of branches that are opened to the plurality of waveguides, respectively, in a state of being opened to the first surface; a flexible resin film fixing step of fixing the flexible resin film to the first surface of the supporting plate by an adhesive or by thermocompression bonding so as to cover the plurality of waveguides and the groove; and a piezoelectric element fixing step of fixing the plurality of piezoelectric elements to the flexible resin film by an insulative adhesive in such a manner that the center regions overlap with the corresponding waveguides and the peripheral regions overlap with the supporting plate in a plan view, wherein the groove and the flexible resin film form the air passage.

Any one of the above-mentioned manufacturing method may further include a lower sealing plate arranging step of preparing a lower sealing plate having a plurality of piezoelectric-element-directed openings that have a size surrounding the corresponding piezoelectric element and having a thickness greater than the piezoelectric element, and then fixing the lower sealing plate to the flexible resin film by an adhesive so that the plurality of piezoelectric elements are arranged within the plurality of piezoelectric-element-directed openings in a plan view; a wiring assembly preparation step of preparing a wiring assembly that includes an insulating base layer, a conductor layer arranged on the base layer and an insulating cover layer enclosing the conductor layer, the conductor layer including first and second wirings that are respectively connected to a pair of first and second electrodes of the piezoelectric element, the base layer being formed with first and second wiring/piezoelectric element connection openings for exposing parts of the first and second wirings, respectively; a wiring assembly fixing step of fixing the base layer to the lower sealing plate by an adhesive; and an electric connection step of electrically connecting a portion of the first wiring that is exposed through the first wiring/piezoelectric element connection opening and a portion of the second wiring that is exposed through the second wiring/piezoelectric element connection opening to the first and second electrodes of the corresponding piezoelectric element, respectively.

### BRIEF DESCRIPTION OF THE DRAWINGS

FIG. 1 is a vertical cross-sectional view of a part of an ultrasonic transducer according to a first embodiment of the present invention.

FIG. 2 is a plan view of a supporting plate in the ultrasonic transducer according to the first embodiment.

FIG. 3A is a plan view of a piezoelectric element in the ultrasonic transducer according to the first embodiment, and FIG. 3B is a cross-sectional view taken along line III-III in FIG. 3A.

FIG. 4 is a partial plan view of the supporting plate in a state of being covered with a flexible resin film, taken along line IV-IV in FIG. 1.

FIG. 5 is a cross-sectional view taken along line V-V in FIG. 4.

FIG. 6 is a cross-sectional view taken along the line VI-VI in FIG. 1.

FIG. 7 is a vertical cross-sectional view of a part of an ultrasonic transducer in accordance with a second embodiment of the present invention.

FIG. 8 is a cross-sectional view taken along line VIII-VIII in FIG. 7.

FIG. 9 is a vertical cross-sectional view of a part of an ultrasonic transducer in accordance with a modified example of the second embodiment.

FIG. 10 is a vertical cross-sectional view of a part of an ultrasonic transducer in accordance with a third embodiment of the present invention.

FIG. 11 is a vertical cross-sectional view of a part of an ultrasonic transducer in accordance with a modified example of the third embodiment.

FIG. 12 is a vertical cross-sectional view of a part of an ultrasonic transducer in accordance with another modified example of the third embodiment.

### EMBODIMENT FOR CARRYING OUT THE INVENTION

### First Embodiment

One embodiment of an ultrasonic transducer according to the present invention will be described below with reference to the accompanying drawings.

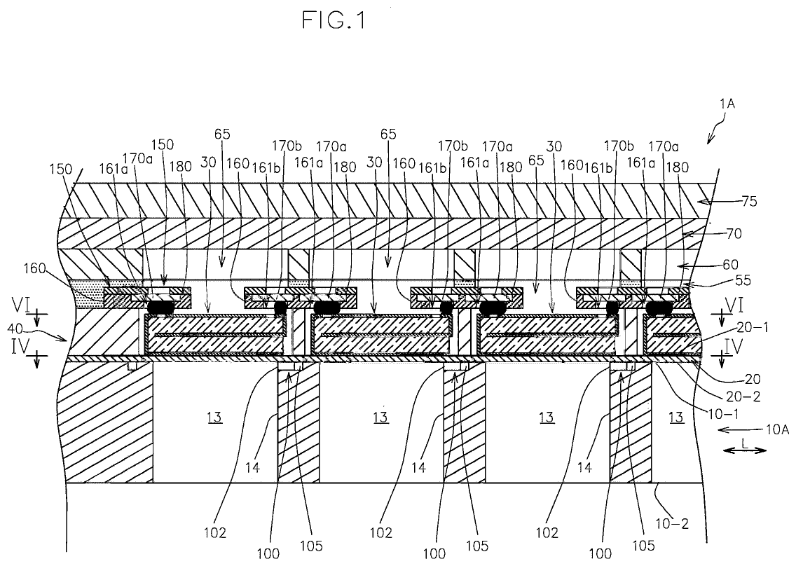

FIG. 1 illustrates a vertically cross-sectional view of a part of an ultrasonic transducer 1A in accordance with the present embodiment.

The ultrasonic transducer 1A includes, as main components, a rigid supporting plate 10A having first and second surfaces 10-1, 10-2 that are positioned on one and the other side in a thickness direction, respectively; a flexible resin film 20 having first and second surfaces 20-1, 20-2 that are positioned on one and the other sides in the thickness direction, respectively, the second surface 20-2 being fixed to the first surface 10-1 of the supporting plate 10A; and a plurality of piezoelectric elements 30 fixed to the first surface 20-1 of the flexible resin film 20.

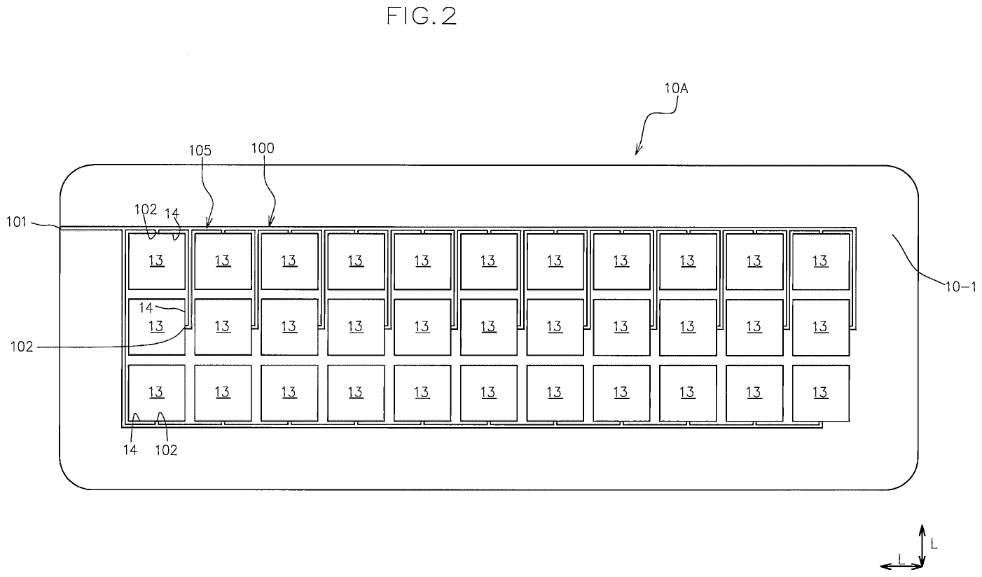

FIG. 2 illustrates a plan view of the supporting plate 10A.

As illustrated in FIGS. 1 and 2, the supporting plate 10A is provided with a plurality of (thirty-three in a 3×11 arrangement) waveguides 13 having first end sides that are opened to the first surface 10-1 and second end sides that are opened to the second surface 10-2.

In the present embodiment, the waveguide 13 has an opening width that is constant over the whole region of the supporting plate 10A in the thickness direction.

The supporting plate 10A may be formed of various rigid materials including a metal such as stainless steel and, in a preferable embodiment, ceramics such as SiC and Al₂O₃ having density smaller and Young's modulus higher than metal.

Forming the supporting plate 10A from ceramics makes it possible to increase a resonance frequency of the supporting plate 10A as much as possible.

The flexible resin film 20 is fixed to the first surface 10-1 of the supporting plate 10A so as to cover the plurality of waveguides 13.

The flexible resin film 20 is formed of an insulating resin such as polyimide having a thickness of 20 μm to 100 μm, for example.

The flexible resin film 20 is fixed to the supporting plate 10A by various methods such as an adhesive or thermocompression bonding.

The ultrasonic transducer 1A includes the same number of (thirty-three in a 3×11 arrangement in the present embodiment) piezoelectric elements 30 as the plurality of waveguides 13.

The piezoelectric element 30 is fixed to the first surface 20-1 of the flexible resin film 20 in such a manner that a center region of the piezoelectric element 30 overlaps with the corresponding waveguide 13 and a peripheral region of the piezoelectric element 30 overlaps with the first surface 10-1 of the supporting plate 10A in a plan view.

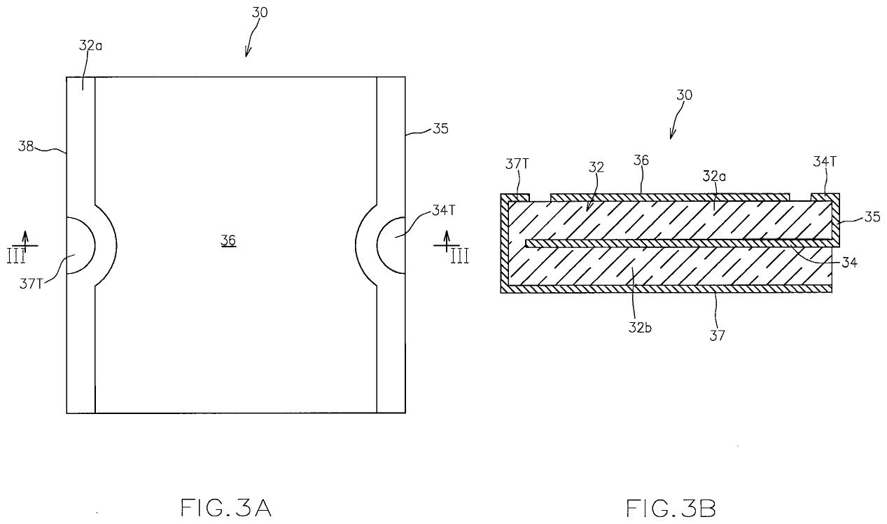

FIG. 3A illustrates a plan view of the piezoelectric element 30.

Further, FIG. 3B illustrates a cross-sectional view taken along line III-III in FIG. 3A.

The piezoelectric element 30 includes a piezoelectric element main body 32 and a pair of first and second application electrodes, and is configured to expand and contract when a voltage is applied between the first and second application electrodes.

As shown in FIGS. 3A and 3B, in the present embodiment, the piezoelectric element 30 is a two-layer laminated type piezoelectric element.

With the laminated type piezoelectric element, it is possible to increase the electric field strength when the same voltage is applied, and increase the expansion/contraction displacement per applied voltage as compared with a single-layer type piezoelectric element.

Specifically, the piezoelectric element 30 includes the piezoelectric element main body 32 formed of a piezoelectric material such as lead zirconate titanate (PZT), an inner electrode 34 that partitions the piezoelectric element main body 32 into a first piezoelectric portion 32a on an upper side and a second piezoelectric portion 32b on a lower side in a thickness direction, a top surface electrode 36 fixed to a part of a top surface of the first piezoelectric portion 32a, a bottom surface electrode 37 fixed to a bottom surface of the second piezoelectric portion 32b, an inner electrode connection member 35 of which one end part is electrically connected to the inner electrode 34 and the other end part forms an inner electrode terminal 34T accessible at the top surface of the first piezoelectric portion 32a while being insulated from the top surface electrode 36, and a bottom surface electrode connection member 38 of which one end part is electrically connected to the bottom surface electrode 37 and the other end part forms a bottom surface electrode terminal 37T accessible at the top surface of the first piezoelectric portion 32a while being insulated from the top surface electrode 36 and the inner electrode 34.

In this case, an outer electrode formed by the top surface electrode 36 and the bottom surface electrode 37 acts as one of first and second electrodes, and the inner electrode 34 acts as the other one of the first and second electrodes.

In the piezoelectric element 30, the first and second piezoelectric portions 32a and 32b have the same polarization direction in the thickness direction, and thus, when a predetermined voltage is applied between the outer electrode and the inner electrode 34 at a predetermined frequency, electric fields in opposite directions are applied to the first and second piezoelectric portions 32a and 32b.

As described above, the top surface electrode 36 and the bottom surface electrode 37 are insulated from each other. Therefore, when the piezoelectric element 30 is formed, it is possible to apply a voltage between the top surface electrode 36 and the bottom surface electrode 37 so that the polarization directions of the first and second piezoelectric portions 32a and 32b may be the same.

In the ultrasonic transducer 1A, the piezoelectric element 30 forms a vibrating body that generates an ultrasonic wave. The vibrating body is configured to have a resonance frequency in a lowest flexural vibration mode higher than a frequency (driving frequency) of a voltage applied to the piezoelectric element 30.

Specifically, to detect an object several meters ahead by a phased array in which a plurality of piezoelectric elements forming vibrating bodies are arranged in parallel, as in the ultrasonic transducer 1A according to the present embodiment, it is necessary to precisely control phases of sonic waves emitted from the plurality of piezoelectric elements 30.

For example, in a phased array in which a plurality of piezoelectric elements are arranged in parallel directly on a rigid supporting plate such as stainless steel, it is necessary to expand and contract the piezoelectric element against the rigidity of the rigid supporting plate so that the vibrating bodies that are formed by the piezoelectric elements and the rigid supporting plate make flexural vibrations with a predetermined amplitude, to secure a level of generated sound pressure.

For this purpose, it is necessary to set a frequency (driving frequency) of the voltage applied to the piezoelectric elements to a frequency in the vicinity of a resonance frequency in the flexural vibration mode of the piezoelectric element.

However, a phase of a frequency response in the flexural vibration mode of the piezoelectric element with respect to the voltage applied to the piezoelectric element changes largely in the vicinity of the resonance frequency of the vibrating body.

Therefore, to precisely control the phases of the sonic waves generated by the plurality of piezoelectric elements with the aim of achieving the function of a phased array sensor, it is necessary to suppress as much as possible “dispersion” in the resonance frequency among the plurality of vibrating bodies, which is very difficult.

With respect to this point, the ultrasonic transducer 1A according to the present embodiment includes, as described above, the rigid supporting plate 10A provided with the plurality of waveguides 13 that are opened to the first surface 10-1 and the second surface 10-2, the flexible resin film 20 fixed to the first surface 10-1 of the supporting plate 10A so as to cover the plurality of waveguides 13, and the plurality of the piezoelectric elements 30 fixed to the first surface 20-1 of the resin film 20 in such a manner that the center regions of the piezoelectric elements 30 overlap with the corresponding waveguides 13 and the peripheral regions of the piezoelectric elements 30 overlaps with the first surface 10-1 of the supporting plate 10A in a plan view.

According to such a configuration, even if the resonance frequency of the piezoelectric element 30 is set to be higher than the frequency of the driving voltage applied to the piezoelectric element, it is possible to sufficiently secure a vibration and an amplitude of the piezoelectric element 30 acting as the vibrating body.

Moreover, when the resonance frequencies of the plurality of vibrating bodies are higher than the driving frequency of the driving voltage applied to the piezoelectric elements 30, even if there is a “dispersion” in the resonance frequencies of the plurality of vibrating bodies, there is no great dispersion in the phases of the frequency response in the flexural vibration mode of the plurality of vibrating bodies.

Therefore, the phases of the sonic waves generated by the plurality of piezoelectric elements 30 acting as the vibrating bodies can be precisely controlled.

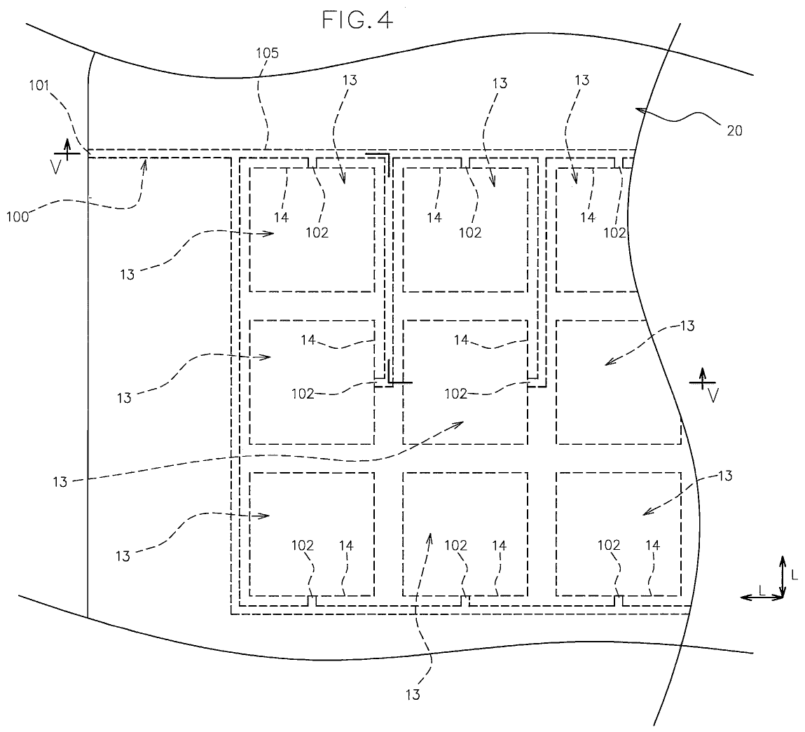

FIG. 4 illustrate a partial plan view of the supporting plate 10A and the flexible resin film 20, taken along line IV-IV in FIG. 1.

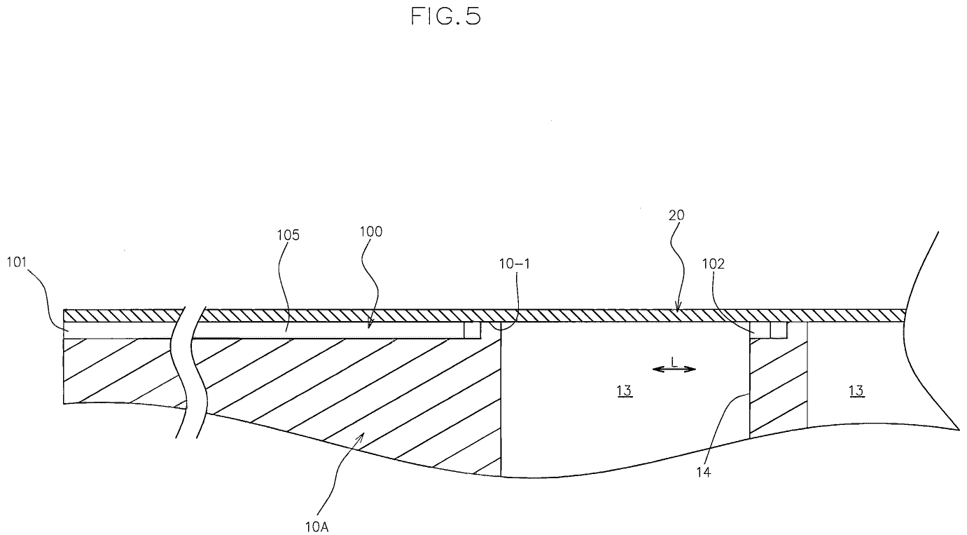

Further, FIG. 5 illustrates a cross-sectional view taken along line V-V in FIG. 4.

As shown in FIGS. 1, 2, 4 and 5, 4, the ultrasonic transducer 1A is provided with an air passage 100 capable of introducing outside air into the plurality of waveguides 13.

The provision of the air passage 100 makes it possible to introduce outside air into the plurality of waveguides 13 so as to effectively prevent or reduce foreign matters such as dust and waterdrop from being adhered to the insides of the plurality of waveguides 13.

In the present embodiment, as shown in FIG. 5, the air passage 100 has an air outlet port 102 opened to an inside wall surface of the supporting plate 10A that forms the waveguide 13 in a state of facing a plate-surface direction L of the supporting plate 10A.

The configuration makes it possible to realize a flow of the outside air that is introduced into the waveguide 13 through the air passage 100, and effectively preventing or reducing transmission characteristic of the sonic wave generated by the vibrating body from being deteriorated by means of the flow of the outside air.

Furthermore, in the present embodiment, as shown in FIGS. 2,4 and 5, the air passage 100 has a single air inlet port 101 on one end side that is opened to an outer surface of the supporting plate 10A, and the plurality of outlet ports 102 on the other end side that are brunched so as to be opened to the plurality of (thirty-three in a 3×11 arrangement in the present embodiment) waveguides 13, respectively.

The configuration makes it possible to introduce outside air into the plurality of waveguides 13 while preventing the supporting plate 10A from becoming large in size.

Moreover, in a case where air is supplied into the plurality of waveguides 13 from an air pressure device such as a pump, it is possible to efficiently supply air from a single air pressure device into the plurality of waveguides 13.

In the present embodiment, as shown in FIG. 5, the supporting plate is formed with a groove 105 opened to the first surface 10-1 of the supporting plate 10A. The flexible resin film 20 is configured to cover, in addition the waveguides 13, the groove 105.

Specifically, in the present embodiment, the groove 105 formed at the first surface 10-1 of the supporting plate 10A and the flexible resin film 20 form the air passage 100.

The configuration makes it possible to easily form the air passage 100.

In addition, the configuration makes it possible to introduce outside air through the air passage 100 into the waveguide 13 in the vicinity of the flexible resin film 20 so as to make outside air flow over the entire region of the waveguide 13.

Hereinafter, optional components of the ultrasonic transducer 1A will be explained.

As shown in FIG. 1, the ultrasonic transducer 1A according to the present embodiment includes a lower sealing plate 40 and a wiring assembly 150 as the optional components, in addition to the supporting plate 10A, the flexible resin film 20 and the plurality of piezoelectric elements 30.

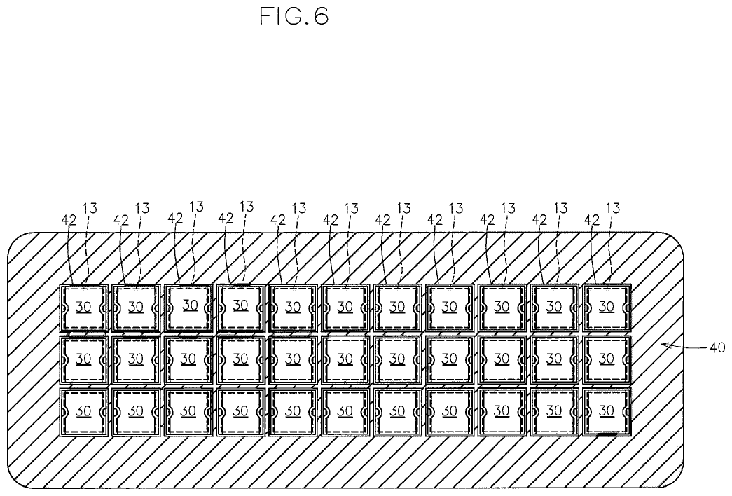

FIG. 6 illustrates a cross-sectional view taken along the line VI-VI in FIG. 1.

As shown in FIG. 6, the lower sealing plate 40 includes a plurality of piezoelectric-element-directed openings 42 having a size surrounding the corresponding piezoelectric element 30. The lower sealing plate 40 is fixed to the first surface 20-1 of the flexible resin film 20 by means of adhesive agent, thermocompression bonding or the like so that the plurality of piezoelectric elements 30 are positioned within the plurality of piezoelectric-element-directed openings 42 in a plan view.

As shown in FIG. 1, the lower sealing plate 40 has a thickness greater than the piezoelectric element 30, so that a first surface of the lower sealing plate 40 is positioned farther away from the flexible resin film 20 than top surface electrode 36, the bottom surface electrode terminal 37T and the inner electrode terminal 34T (see FIG. 3) are in a state where the lower sealing plate 40 is fixed to the first surface 20-1 of the flexible resin film 20.

The lower sealing plate 40 is formed of a rigid material including a metal such as stainless steel, carbon fiber reinforced plastic, ceramics, or the like.

The lower sealing plate 40 seals sides of a piezoelectric element group including the plurality of piezoelectric elements 30, and also acts as a mounting base to which the wiring assembly 150 is fixed.

The wiring assembly 150 is used for transmitting an applied voltage supplied from the outside to the plurality of piezoelectric elements 30.

As illustrated in FIG. 1, the wiring assembly 150 includes an insulating base layer 160 fixed to the lower sealing plate 40 by adhesive agent or the like, a conductor layer 170 fixed to the base layer 160, and an insulating cover layer 180 enclosing the conductor layer 170.

The base layer 160 and the cover layer 180 are formed of an insulating resin such as polyimide, for example.

The conductor layer 170 is formed of a conductive metal such as Cu, for example.

The conductor layer 170 may be formed by laminating a Cu foil that has a thickness of about 12 to 25 μm on the base layer 160 and then removing unnecessary portions from the Cu foil by etching.

An exposed portion of Cu forming the conductor layer 170 may be preferably plated with Ni and Au.

In the present embodiment, the conductor layer 170 includes a first wiring 170a and a second wiring 170b that are respectively connected to a first electrode (the outer electrode 36, 37 in the present embodiment) and a second electrode (the inner electrode 34 in the present embodiment) of the piezoelectric element 30.

The base layer 160 is formed with a first wiring/piezoelectric element connection opening 161a for connecting the first wiring 170a to the corresponding first electrode of the piezoelectric element 30 and a second wiring/piezoelectric element connection opening 161b for connecting the second wiring 170b to the corresponding second electrode of the piezoelectric element 30.

In the present embodiment, as described above, the top surface electrode 36 and the bottom surface electrode 37 act as the first electrode, and the inner electrode 34 acts as the second electrode.

Accordingly, a portion of the first wiring 170a that is exposed through the first wiring/piezoelectric element connection opening 161a is electrically connected to both of a part of the top surface electrode 36 and the bottom surface electrode terminal 37T by a conductive adhesive or solder, for example.

Also, a portion of the second wiring 170b that is exposed through the second wiring/piezoelectric element connection opening 161b is electrically connected to the inner electrode terminal 34T by a conductive adhesive or solder, for example.

The cover layer 180 is formed with a first wiring/outside connection opening and a second wiring/outside connection opening for electrically connecting the first and second wirings 170a, 170b to corresponding outside members, respectively.

As shown in FIG. 1, the ultrasonic transducer 1A according to the present embodiment further includes an upper sealing plate 60 fixed to the top surfaces of the lower sealing plate 40 and the wiring assembly 150 via a flexible resin 55.

The upper sealing plate 60 includes opening parts 65 at positions corresponding to the plurality of piezoelectric elements 30.

With the upper sealing plate 60, it is possible to obtain a stable support structure for the wiring assembly 150 while preventing an influence on a flexural vibration operation of the vibrating body as much as possible.

For example, the upper sealing plate 60 is formed of a metal such as stainless steel having a thickness of 0.1 mm to 0.3 mm, carbon fiber reinforced plastic, ceramics, and the like.

The ultrasonic transducer 1A according to the present embodiment further includes a sound absorbing member 70 fixed to the top surface of the upper sealing plate 60 by adhesion or the like to cover the plurality of opening parts 65 of the upper sealing plate 60.

The sound absorbing member 70 is formed of a silicone resin having a thickness of about 0.3 mm to 1.5 mm or another foamed resin, for example.

With the sound absorbing member 70, it is possible to effectively suppress ultrasonic waves generated by the piezoelectric elements 30 from being emitted to a side opposite to the side to which the sonic waves are to be emitted (lower side in FIG. 1).

The ultrasonic transducer 1A further includes a reinforcing plate 75 fixed to the top surface of the sound absorbing member 70 by adhesion or the like.

For example, the reinforcing plate 75 is formed of a metal such as stainless steel having a thickness of about 0.2 mm to 0.5 mm, carbon fiber reinforced plastic, ceramics, and the like.

With the reinforcing plate 75, it is possible to prevent an external force from affecting the supporting plate 10 and the piezoelectric elements 30 as much as possible.

The ultrasonic transducer 1A according to the present embodiment may be manufactured by a manufacturing method including,
a supporting plate forming step of forming the supporting plate 10A by preparing a rigid plate member having a thickness, which is a distance between the first surface 10-1 on one side and the second surface 10-2 on the other side in the thickness direction, same as the depth of the plurality of waveguides 13, and forming the plurality of waveguides 13 in the rigid plate member by etching and also forming the groove 105 on the first surface 10-1 of the rigid plate member by half-etching so that the groove 105 has one side opened to an outer side wall of the rigid plate member and the other side divided into a plurality of branches that are opened to the plurality of waveguides 13, respectively, in a state of being opened to the first surface 10-1,
a flexible resin film fixing step of fixing the flexible resin film 20 to the first surface 10-1 of the supporting plate 10A by an adhesive or by thermocompression bonding so as to cover the plurality of waveguides 13 and the groove 105, and
a piezoelectric element fixing step of fixing the plurality of piezoelectric elements 30 to the flexible resin film 20 by an insulative adhesive in such a manner that the center regions overlap with the corresponding waveguides 13 and the peripheral regions overlap with the supporting plate 10A in a plan view,
wherein the groove 105 and the flexible resin film 20 form the air passage 100.

The manufacturing method may further include,
a lower sealing plate arranging step of preparing the lower sealing plate 40 having the plurality of piezoelectric-element-directed openings 42 that have a size surrounding the corresponding piezoelectric element 30 and having a thickness greater than the piezoelectric element 30, and then fixing the lower sealing plate 40 to the flexible resin film 20 by an adhesive so that the plurality of piezoelectric elements 30 are arranged within the plurality of piezoelectric-element-directed openings 42 in a plan view,
a wiring assembly preparation step of preparing the wiring assembly 150 that includes the insulating base layer 160, the conductor layer 170 arranged on the base layer 16, and the insulating cover layer 180 enclosing the conductor layer 170, the conductor layer 170 including the first and second wirings 170a, 170b that are respectively connected to the pair of first and second electrodes of the piezoelectric element 30, the base layer 160 being formed with the first and second wiring/piezoelectric element connection openings 161a, 161b for exposing parts of the first and second wirings 170a, 170b, respectively,
a wiring assembly fixing step of fixing the base layer 160 to the lower sealing plate 40 by an adhesive, and
an electric connection step of electrically connecting the portion of the first wiring 170a that is exposed through the first wiring/piezoelectric element connection opening 161a and the portion of the second wiring 170b that is exposed through the second wiring/piezoelectric element connection opening 161b to the first and second electrodes of the corresponding piezoelectric element 30, respectively.

### Second Embodiment

Another embodiment of the ultrasonic transducer according to the present invention will be described below with reference to the accompanying drawings.

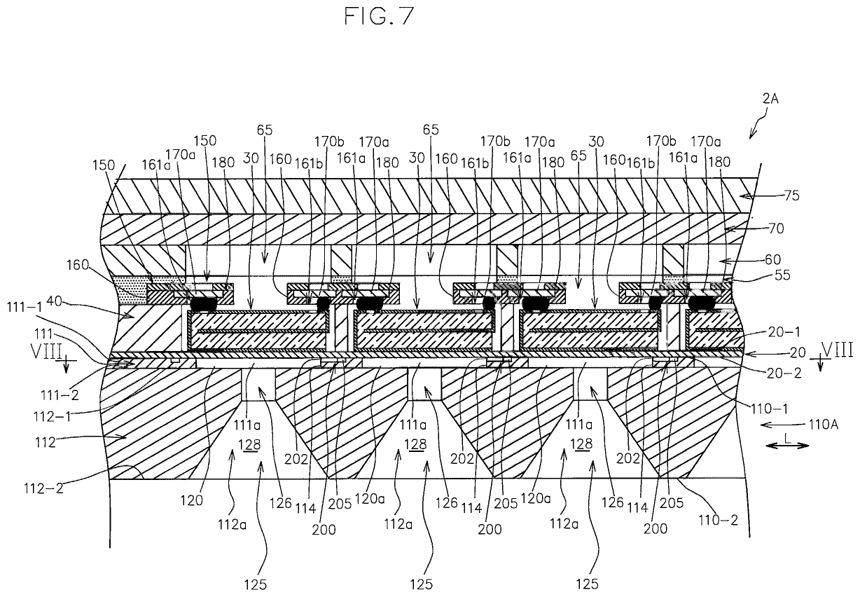

FIG. 7 illustrates a vertically cross-sectional view of a part of an ultrasonic transducer 2A in accordance with the present embodiment.

In the drawing, the same reference numerals are applied to the same components as those in the first embodiment above, and the description thereof will be omitted as appropriate.

As shown in FIG. 7, the ultrasonic transducer 2A in accordance with the present embodiment is different from the ultrasonic transducer 1A in accordance with the first embodiment in that the supporting plate 10A is changed to a supporting plate 110A.

Specifically, the ultrasonic transducer 2A includes, as main components, the rigid supporting plate 110A having first and second surfaces 110-1, 110-2 that are positioned on one and the other side in a thickness direction, respectively; the flexible resin film 20 fixed to the first surface 110-1 of the supporting plate 110A; and the plurality of piezoelectric elements 30 fixed to the first surface 20-1 of the flexible resin film 20.

The supporting plate 10 is provided with a plurality of cavity portions 120 opened to the first surface 110-1, and a plurality of waveguides 125 having first end portions on one side that are respectively opened to bottom surfaces of the plurality of cavity portions 120 and second end portions on the other side that are opened to the second surface 110-2, the first end portion of the waveguide 125 having an opening width smaller than that of the cavity portion 120.

The cavity portion 120 and the waveguide 125 form a sound passage of the ultrasonic wave that the piezoelectric element 30 generates and/or receive.

The cavity portion 120 has an opening width set in such a manner that the center region of the piezoelectric element 30 overlaps with the corresponding cavity portion 120 in a plan view and the peripheral region of the piezoelectric element 30 surrounds the corresponding cavity portion 120 in a plan view.

The waveguide 125 includes a tubular portion 126 opened to the bottom surfaces of the corresponding cavity portion 120, and a horn portion 128 opened to the second surface 110-2 of the supporting plate 110A.

As shown in FIG. 7, the tubular portion 126 has a tubular shape with an opening width that has is smaller than that of the cavity portion 120 and is constant over the whole region of the tubular portion 126 in the thickness direction.

The horn portion 128 has a horn shape having an opening width that is increased as being close in a thickness direction to an end portion (sonic wave radiation opening), which is opened to the second surface 110-2 of the supporting plate 110A, from an end portion connected to the tubular portion 126.

The thus configured ultrasonic transducer 2A makes it possible to increase the sound pressure level of the ultrasonic waves radiated from the vibrating body piezoelectric element 30 and the flexible resin film 20.

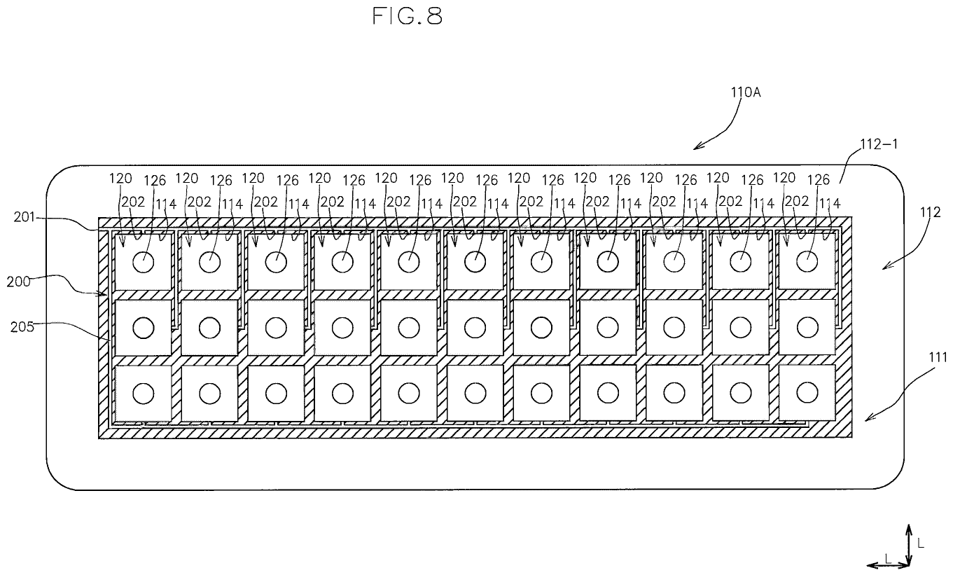

FIG. 8 illustrates a cross-sectional view of the supporting plate 110A taken along line VIII-VIII in FIG. 7.

As shown in FIGS. 7 and 8, the supporting plate 110A is provided with an air passage 200 capable of introducing outside air into the plurality sound passages formed by the plurality of cavity portions 120 and the plurality of waveguides 125.

In the same manner as the first embodiment, the ultrasonic transducer 2A in accordance with the present embodiment makes it also possible to effectively prevent or reduce foreign matters such as dust and waterdrop from being adhered to the insides of the sonic passages by means of outside air introduced through the air passage 200.

As shown in FIG. 7, the air passage 200 has an air outlet port 202 opened to an inside wall surface 114 of the supporting plate 110A that forms the sound passage in a state of facing a plate-surface direction L of the supporting plate 110A.

In accordance with the configuration, the outside air, which is introduced into the sound passage through the air passage 200, makes it possible to form an air flow while effectively preventing or reducing transmission characteristic of the sonic wave that the vibrating body generates or receives from being deteriorated.

As with the air passage 100 in the first embodiment, the air passage 200 has a single air inlet port 201 on one end side that is opened to an outer surface of the supporting plate 110A, and the plurality of outlet ports 102 on the other end side that are brunched so as to be opened to the plurality of (thirty-three in a 3×11 arrangement in the present embodiment) sound passages, respectively.

As shown in FIG. 7, in the present embodiment, the supporting plate 110A is formed with a groove 205 having one side opened to an outer side wall of the support plate 110A and the other side opened to the plurality of cavity portions 120, in a state of opened to the first surface. The groove 205 and the flexible resin film 20 covering the groove 205 as well as the cavity portions 120 form the air passage 200.

The configuration makes it possible to easily form the air passage 200 and also introduce outside air through the air passage 200 into the cavity portion 120 in the vicinity of the flexible resin film 20 so as to make outside air, which is introduced through the air passage 200, flow over the entire region of the sound passage formed by the cavity portion 120 and the waveguide 125.

As shown in FIG. 7, in the present embodiment, the supporting plate 110A includes a first plate body 111 that has a thickness, which is a distance between a first surface 111-1 on one side and a second surface 111-2 on the other side in the thickness direction, same as the depth of the plurality of cavity portions 120 and is formed with a plurality of through holes 111a having opening widths same as those of the plurality of cavity portions 120 and penetrating between the first and second surfaces 111-1, 111-2, and a second plate body 112 that has a thickness, which is a distance between a first surface 112-1 on one side and a second surface 112-2 on the other side in the thickness direction, same as the depth of the plurality of waveguides 125 and is formed with a plurality of through holes 112a having opening widths same as those of the plurality of waveguides. The supporting plate 110A is formed by the first and second plate bodies 111, 112 fixed to each other in a state where the second surface 111-2 of the first plate body 111 and the first surface 112-1 of the second plate body 112 are disposed in contact with each other.

The groove 205 forming the air passage 200 is formed on the first surface 111-1 (a opposite surface from the second plate body 112) of the first plate body 111 come contact

The first and second plate bodies 111, 112 may be formed of various rigid materials including a metal such as stainless steel and, in a preferable embodiment, ceramics such as SiC and Al₂O₃ having density smaller and Young's modulus higher than metal.

The ultrasonic transducer 2A may be manufactured, for example, by a manufacturing method including,
a step of forming the first plate body 111 by preparing a first rigid plate member having a thickness, which is a distance between the first surface 111-1 on one side and the second surface 111-2 on the other side in the thickness direction, same as the depth of the plurality of cavity portions 120, and forming, by etching the first rigid plate member, a plurality of through holes 111a having opening widths same as those of the plurality of cavity portions 120 and penetrating between the first and second surfaces 111-1, 111-2, and also forming, by half-etching the first surface 111-1 of the first rigid plate member, the groove 205 having one side opened to an outer side wall of the first rigid plate member and the other side divided into a plurality of branches that are opened to the plurality of through holes 111a, respectively, in a state of opened to the first surface 111-1,
a step of forming the second plate body 112 by preparing a second rigid plate member having a thickness, which is a distance between the first surface 112-1 on one side and the second surface 112-2 on the other side in the thickness direction, same as the depth of the plurality of waveguides 125, and forming, by etching the second rigid plate member, a plurality of through holes 112a having opening widths same as those of the plurality of waveguides 125,
a step of forming the supporting plate 110A by adhering the second surface 111-2 of the first plate body 111 to the first surface 112-1 of the second plate body 112 with an adhesive,
a flexible resin film fixing step of fixing the flexible resin film 20 to the supporting plate 110A by an adhesive or by thermocompression bonding so as to cover the plurality of through holes 111a and the groove 205 that are formed in the first plate body, and
a piezoelectric element fixing step of fixing the plurality of piezoelectric elements 30 to the flexible resin film 20 by an insulative adhesive in such a manner that the center regions overlap with the corresponding cavity portions 120 and the peripheral regions overlap with the supporting plate 110A in a plan view,
wherein the groove 205 and the flexible resin film 20 form the air passage 200.

The manufacturing method may also further include the lower sealing plate arranging step, the wiring assembly preparation step, the wiring assembly fixing step and the electric connection step.

In the present embodiment, as described above, the supporting plate 110A includes the first and second plate bodies 111, 112 that are separate from each other, and is formed by the first and second bodies 111, 112 fixed in a state of being laminated to each other. However, it is possible to use a supporting plate 110B that is formed by a single rigid plate member in place of the supporting plate 110A.

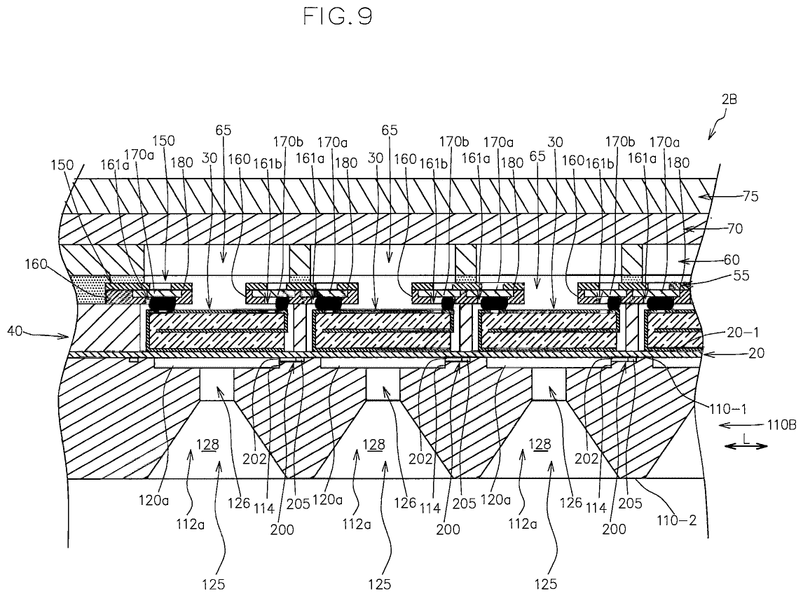

FIG. 9 illustrates a vertically cross-sectional view of a part of an ultrasonic transducer 2B with the supporting plate 110B in accordance with a modified example of the present embodiment.

For example, the ultrasonic transducer 2B may be manufactured by a manufacturing method including,
a step of forming the supporting plate 110B by preparing a rigid plate member having a thickness, which is a distance between the first surface 111-1 on one side and the second surface 111-2 on the other side in the thickness direction, same as the total depth of the plurality of cavity portions 120 and the plurality of waveguides 125, and forming, by half-etching the first rigid plate member, the plurality of cavity portions 120 and the groove 205 having one side opened to an outer side wall of the rigid plate member and the other side divided into a plurality of branches that are opened to the plurality of cavity portions 120, respectively, in a state of opened to the first surface 111-1, and also forming, by etching the first surface or the second surface, the plurality of waveguides 125,
a flexible resin film fixing step of fixing the flexible resin film 20 to the supporting plate 110B by an adhesive or by thermocompression bonding so as to cover the plurality of cavity portions 120 and the groove 205, and
a piezoelectric element fixing step of fixing the plurality of piezoelectric elements 30 to the flexible resin film 20 by an insulative adhesive in such a manner that the center regions overlap with the corresponding cavity portions 120 and the peripheral regions overlap with the supporting plate 110B in a plan view,
wherein the groove 205 and the flexible resin film 20 form the air passage 200.

The manufacturing method may also further include the lower sealing plate arranging step, the wiring assembly preparation step, the wiring assembly fixing step and the electric connection step.

In the manufacturing method of the ultrasonic transducer 2B shown in FIG. 9, in a case where the waveguide 125 includes the horn portion 128, the horn portion 128 is formed by half-etching the second surface 110-2 of the rigid plate member.

The tubular portion 126 can be formed by half-etching the first surface 110-1 of the rigid plate member at the time when the cavity portion 120 is formed, or can be formed by half-etching the second surface 110-2 of the rigid plate member at the time when the horn portion 128 is formed.

### Third Embodiment

Still another embodiment of the ultrasonic transducer according to the present invention will be described below with reference to the accompanying drawings.

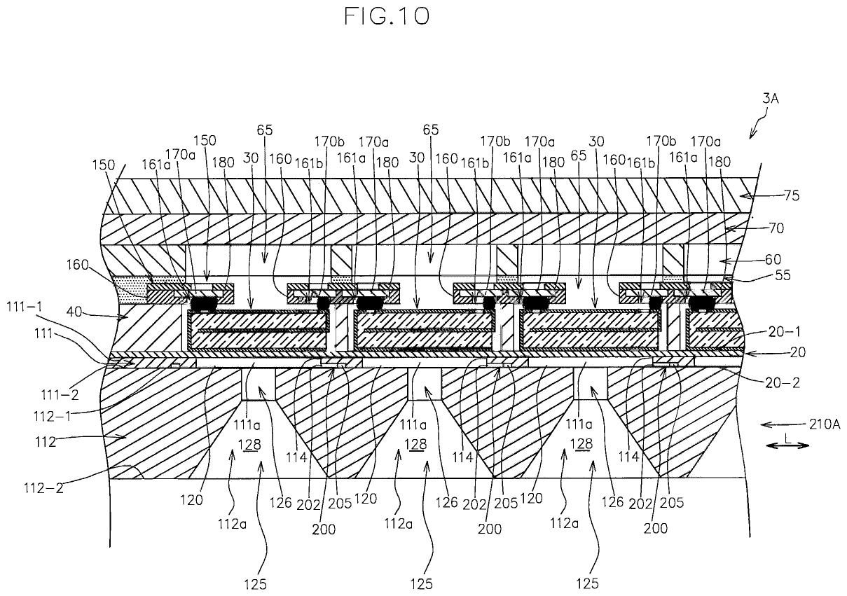

FIG. 10 illustrates a vertically cross-sectional view of a part of an ultrasonic transducer 3A in accordance with the present embodiment.

In the drawing, the same reference numerals are applied to the same components as those in the first and second embodiments above, and the description thereof will be omitted as appropriate.

The ultrasonic transducer 3A in accordance with the present embodiment is different from the ultrasonic transducer 2A in accordance with the second embodiment in that the supporting plate 110A is changed to a supporting plate 210A.

The supporting plate 210A is same as the supporting plate 110A in that the supporting plate 210A includes the first plate body 111 with the plurality of cavity portions 120 and the second plate body 112 with the plurality of waveguides 125.

On the other hand, the supporting plate 210A is different from the supporting plate 110A in that the air passage 200 is arranged between the first plate body 111 and the second plate body 112.

Specifically, in the present embodiment, the first plate body 111 is formed with the groove 205 having one side opened to an outer side wall of the first plate body 111 and the other side opened to the plurality of cavity portions 120, in a state of opened to the second surface 111-2.

The groove 205 is covered by the first surface 112-1 of the second plate body 112 when the second surface 111-2 of the first plate body 111 is overlapped with the first surface 112-1 of the second plate body 112. The groove 205 and the first surface 112-1 of the second plate body 112 form the air passage 200.

The ultrasonic transducer 3A may be manufactured, for example, by a manufacturing method including,
a step of forming the first plate body 111 by preparing a first rigid plate member having a thickness, which is a distance between the first surface 111-1 on one side and the second surface 111-2 on the other side in the thickness direction, same as the depth of the plurality of cavity portions 120, and forming, by etching the first rigid plate member, a plurality of through holes 111a having opening widths same as those of the plurality of cavity portions 120 and penetrating between the first and second surfaces 111-1, 111-2, and also forming, by half-etching the second surface 111-2 of the first rigid plate member, the groove 205 having one side opened to an outer side wall of the first rigid plate member and the other side divided into a plurality of branches that are opened to the plurality of through holes 111a, respectively, in a state of opened to the second surface 111-2,
a step of forming the second plate body 112 by preparing a second rigid plate member having a thickness, which is a distance between the first surface 112-1 on one side and the second surface 112-2 on the other side in the thickness direction, same as the depth of the plurality of waveguides 125, and forming, by etching the second rigid plate member, a plurality of through holes 112a having opening widths same as those of the plurality of waveguides 125,
a step of forming the supporting plate 210A by adhering the second surface 111-2 of the first plate body 111 to the first surface 112-1 of the second plate body 112 with an adhesive,
a flexible resin film fixing step of fixing the flexible resin film 20 to the supporting plate 210A by an adhesive or by thermocompression bonding so as to cover the plurality of through holes 111a formed in the first plate body, and
a piezoelectric element fixing step of fixing the plurality of piezoelectric elements 30 to the flexible resin film 20 by an insulative adhesive in such a manner that the center regions overlap with the corresponding cavity portions 120 and the peripheral regions overlap with the supporting plate 210A in a plan view,
wherein the groove 205 and the first surface 112-1 of the second plate body 112 form the air passage 200.

The manufacturing method may also further include the lower sealing plate arranging step, the wiring assembly preparation step, the wiring assembly fixing step and the electric connection step.

In the present embodiment, the groove 205 is formed on the second surface 112-1 of the first plate body 111. Alternatively, it is possible to form the groove 205 on the first surface 112-1 of the second plate body 112.

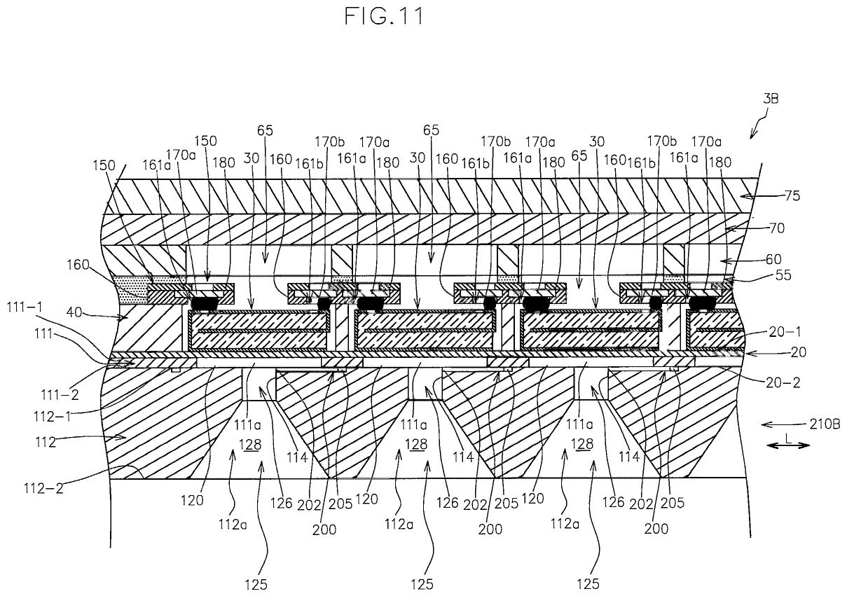

FIG. 11 illustrates a vertically cross-sectional view of a part of an ultrasonic transducer 3B in accordance with a modified example of the present embodiment, which has been thus modified.

As shown in FIG. 11, in the ultrasonic transducer 3B in accordance with the modified example, the groove 205 is formed in the second plate body 112 in such a manner that one side is opened to the outer side wall of the first plate body and the other side is divided into a plurality of branches that are opened to the corresponding cavity portions 120 or waveguides 125 in a state of opened to the first surface 112-1.

The groove 205 is covered by the second surface 111-2 of the first plate body 111 when the second surface 111-2 of the first plate body 111 is overlapped with the first surface 112-1 of the second plate body 112. The groove 205 and the second surface 111-2 of the first plate body 111 form the air passage 200.

The ultrasonic transducer 3B may be manufactured, for example, by a manufacturing method including,
a step of forming the first plate body 111 by preparing a first rigid plate member having a thickness, which is a distance between the first surface 111-1 on one side and the second surface 111-2 on the other side in the thickness direction, same as the depth of the plurality of cavity portions 120, and forming, by etching the first rigid plate member, a plurality of through holes 111a having opening widths same as those of the plurality of cavity portions 120 and penetrating between the first and second surfaces 111-1, 111-2,
a step of forming the second plate body 112 by preparing a second rigid plate member having a thickness, which is a distance between the first surface 112-1 on one side and the second surface 112-2 on the other side in the thickness direction, same as the depth of the plurality of waveguides 125, and forming, by etching the second rigid plate member, a plurality of through holes 112a having opening widths same as those of the plurality of waveguides 125, and also forming, by half etching the first surface 112-1 of the second rigid plate member, the groove 205 having one side opened to an outer side wall of the second rigid plate member and the other side divided into a plurality of branches, in a state of opened to the first surface 112-1,
a step of forming the supporting plate 210B by adhering the second surface 111-2 of the first plate body 111 to the first surface 112-1 of the second plate body 112 with an adhesive,
a flexible resin film fixing step of fixing the flexible resin film 20 to the supporting plate 210B by an adhesive or by thermocompression bonding so as to cover the plurality of through holes 111a formed in the first plate body, and
a piezoelectric element fixing step of fixing the plurality of piezoelectric elements 30 to the flexible resin film 20 by an insulative adhesive in such a manner that the center regions overlap with the corresponding cavity portions 120 and the peripheral regions overlap with the supporting plate 210B in a plan view,
wherein the groove 205 and the second surface 111-2 of the first plate body 111 form the air passage 200.

The manufacturing method may also further include the lower sealing plate arranging step, the wiring assembly preparation step, the wiring assembly fixing step and the electric connection step.

In place of the supporting plates 210A, 210B, it is also possible to use a supporting plate 210C in which the groove 205 is formed on both the second surface 111-2 of the first plate body 111 and the first surface 112-1 of the second plate body 112.

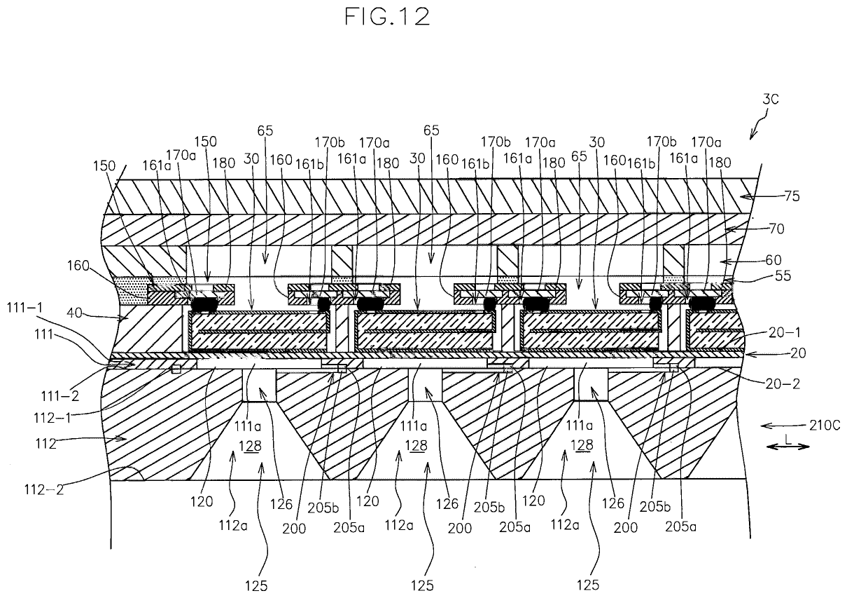

FIG. 12 illustrates a vertically cross-sectional view of a part of an ultrasonic transducer 3C in accordance with another modified example of the present embodiment, which has been thus modified.

The ultrasonic transducer 3C may be manufactured, for example, by a manufacturing method including,
a step of forming the first plate body 111 by preparing a first rigid plate member having a thickness, which is a distance between the first surface 111-1 on one side and the second surface 111-2 on the other side in the thickness direction, same as the depth of the plurality of cavity portions 120, and forming, by etching the first rigid plate member, a plurality of through holes 111a having opening widths same as those of the plurality of cavity portions 120 and penetrating between the first and second surfaces 111-1, 111-2, and also forming, by half-etching the second surface 111-2 of the first rigid plate member, a first groove 205a having one side opened to an outer side wall of the first rigid plate member and the other side divided into a plurality of branches that are opened to the plurality of through holes 111a, respectively, in a state of opened to the second surface 111-2,
a step of forming the second plate body 112 by preparing a second rigid plate member having a thickness, which is a distance between the first surface 112-1 on one side and the second surface 112-2 on the other side in the thickness direction, same as the depth of the plurality of waveguides 125, and forming, by etching the second rigid plate member, a plurality of through holes 112a having opening widths same as those of the plurality of waveguides 125, and also forming, by half etching the first surface 112-1 of the second rigid plate member, a second groove 205b having one side opened to an outer side wall of the second rigid plate member and the other side divided into a plurality of branches, in a state of opened to the first surface 112-1,
a step of forming the supporting plate 210C by adhering the second surface 111-2 of the first plate body 111 to the first surface 112-1 of the second plate body 112 with an adhesive,
a flexible resin film fixing step of fixing the flexible resin film 20 to the supporting plate 210C by an adhesive or by thermocompression bonding so as to cover the plurality of through holes 111a formed in the first plate body, and
a piezoelectric element fixing step of fixing the plurality of piezoelectric elements 30 to the flexible resin film 20 by an insulative adhesive in such a manner that the center regions overlap with the corresponding cavity portions 120 and the peripheral regions overlap with the supporting plate 210C in a plan view,
wherein the air passage 200 is formed by the first and second grooves 205a, 205b that are abutted against each other when the second surface 111-2 of the first plate body 111 is fixed to the first surface 112-1 of the second plate body 112.

The manufacturing method may also further include the lower sealing plate arranging step, the wiring assembly preparation step, the wiring assembly fixing step and the electric connection step.

### DESCRIPTION OF THE REFERENCE NUMERALS

1A-3C ultrasonic transducer
10A, 110A-110B, 210A-210C supporting plate
10-1, 110-1 first surface of supporting plate
10-2, 110-2 second surface of supporting plate
13, 125 waveguide
20 flexible resin film
30 piezoelectric element
40 lower sealing plate
100, 200 air passage
101, 201 inlet port
102, 202 outlet port
105, 205 groove
111 first plate body
112 second plate body
120 cavity portion
160 base layer
161a first wiring/piezoelectric element connection opening
161b second wiring/piezoelectric element connection opening
170 conductor layer
170a, 170b first and second wirings
180 cover layer

1. An ultrasonic transducer comprising:
a rigid supporting plate having first and second surfaces on one side and the other side in a thickness direction, respectively, the supporting plate being provided with a plurality of cavity portions opened to the first surface, and a plurality of waveguides having first end portions on one side that are opened to bottom surfaces of the corresponding cavity portions and second end portions on the other side that are opened to the second surface;
a flexible resin film that is fixed to the first surface of the supporting plate so as to cover the plurality of cavity portions;
the same number of piezoelectric elements as the cavity portions that are fixed to the flexible resin film so that their center regions overlap with the corresponding cavity portions and their peripheral regions overlap with the first surface of the supporting plate in a plan view; and
an air passage capable of introducing outside air into a plurality of sound passages formed by the plurality of cavity portions and the plurality of waveguides.

2. The ultrasonic transducer according to claim 1, wherein the air passage has an air outlet port opened to an inside wall surface of the supporting plate that forms the sound passage and facing a plate-surface direction of the supporting plate.

3. The ultrasonic transducer according to claim 1, wherein the air passage has a single air inlet port on one end side that is opened to an outer surface of the supporting plate, and a plurality of the outlet ports on the other end side that are opened to the plurality of sound passages, respectively.

4. The ultrasonic transducer according to claim 1,
wherein the supporting plate is formed with a groove opened to the first surface,
wherein the flexible resin film that is configured to cover the groove as well as the plurality of cavity portions, and
wherein the air passage is formed by the groove formed in the supporting plate and the flexible resin film.

5. The ultrasonic transducer according to claim 1,
wherein the supporting plate includes a first plate body formed with a plurality of through holes having the opening widths same as those of the plurality of cavity portions and a second plate body formed with a plurality of through holes having the opening widths same as those of the plurality of waveguides, the first and second plate bodies being laminated in the thickness direction and fixed to each other,
wherein at least one of the first and second plate bodies is formed with a groove opened to an abutted surface, and
wherein the air passage is formed by the groove and an abutted surface of the other one of the first and second plate bodies that covers the groove.

6. An ultrasonic transducer comprising:
a rigid supporting plate having first and second surfaces on one side and the other side in a thickness direction, respectively, the supporting plate being provided with a plurality of waveguides penetrating between the first and second surfaces;
a flexible resin film that is fixed to the first surface of the supporting plate so as to cover the plurality of waveguides;
the same number of piezoelectric elements as the waveguides that are fixed to the flexible resin film so that their center regions overlap with the corresponding waveguides and their peripheral regions overlap with the first surface of the supporting plate in a plan view; and
an air passage capable of introducing outside air into the plurality of waveguides.

7. The ultrasonic transducer according to claim 6, wherein the air passage has an air outlet port opened to an inside wall surface of the supporting plate that forms the waveguide and facing a plate-surface direction of the supporting plate.

8. The ultrasonic transducer according to claim 6, wherein the air passage has a single air inlet port on one end side that is opened to an outer surface of the supporting plate, and a plurality of the outlet ports on the other end side that are opened to the plurality of waveguides, respectively.

9. The ultrasonic transducer according to claim 6,
wherein the supporting plate is formed with a groove opened to the first surface,
wherein the flexible resin film is configured to cover the groove as well as the plurality of waveguides, and
wherein the air passage is formed by the groove formed in the supporting plate and the flexible resin film.

10. A manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method comprising:
a step of forming a first plate body by preparing a first rigid plate member having a thickness, which is a distance between a first surface on one side and a second surface on the other side in a thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the first surface of the first rigid plate member, the groove having one side opened to an outer side wall of the first rigid plate member and the other side divided into a plurality of branches that are opened to the plurality of through holes, respectively, in a state of opened to the first surface;
a step of forming a second plate body by preparing a second rigid plate member having a thickness, which is a distance between a first surface on one side and a second surface on the other side in a thickness direction, same as the depth of the plurality of waveguides, and forming, by etching the second rigid plate member, a plurality of through holes having opening widths same as those of the plurality of waveguides;
a step of forming the supporting plate by adhering the second surface of the first plate body to the first surface of the second plate body with an adhesive;
a flexible resin film fixing step of fixing the flexible resin film to the supporting plate by an adhesive or by thermocompression bonding so as to cover the plurality of through holes and the groove that are formed in the first plate body; and
a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view,
wherein the groove and the flexible resin film form the air passage.

11. A manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method comprising:
a step of forming the supporting plate by preparing a rigid plate member having a thickness, which is a distance between a first surface on one side and a second surface on the other side in the thickness direction, same as the total depth of the plurality of cavity portions and the plurality of waveguides, and forming, by half-etching the first rigid plate member, the plurality of cavity portions and a groove having one side opened to an outer side wall of the rigid plate member and the other side divided into a plurality of branches that are opened to the plurality of cavity portions, respectively, in a state of opened to the first surface, and also forming the plurality of waveguides by etching the first surface or the second surface of the rigid plate member;
a flexible resin film fixing step of fixing the flexible resin film to the supporting plate by an adhesive or by thermocompression bonding so as to cover the plurality of cavity portions and the groove; and
a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view,
wherein the groove and the flexible resin film form the air passage.

12. A manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method comprising:
a step of forming a first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the second surface of the first rigid plate member, the groove having one side opened to an outer side wall of the first rigid plate member and the other side divided into a plurality of branches that are opened to the plurality of through holes, respectively, in a state of opened to the second surface;
a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides;
a step of forming the supporting plate by adhering the second surface of the first plate body to the first surface of the second plate body with an adhesive;
a flexible resin film fixing step of fixing the flexible resin film to the supporting plate by an adhesive or by thermocompression bonding so as to cover the plurality of through holes formed in the first plate body; and
a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view,
wherein the groove and the first surface of the second plate body form the air passage.

13. A manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method comprising:
a step of forming the first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces;
a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides, and also forming, by half etching the first surface of the second rigid plate member, a groove having one side opened to an outer side wall of the second rigid plate member and the other side divided into a plurality of branches, in a state of opened to the first surface;
a step of forming the supporting plate by adhering the second surface of the first plate body to the first surface of the second plate body with an adhesive;
a flexible resin film fixing step of fixing the flexible resin film to the supporting plate by an adhesive or by thermocompression bonding so as to cover the plurality of through holes formed in the first plate body; and
a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view,
wherein the groove and the second surface of the first plate body form the air passage.

14. A manufacturing method of an ultrasonic transducer that includes a rigid supporting plate having first and second surfaces on one side and the other side in a thickness direction, respectively and provided with a plurality of cavity portions opened to the first surface and a plurality of waveguides having first end portions on one side that have opening widths smaller than those of the cavity portions and are opened to bottom surfaces of the corresponding cavity portions and second end portions on the other side that are opened to the second surface; a flexible resin film that is fixed to the first surface of the supporting plate so as to cover the plurality of cavity portions; the same number of piezoelectric elements as the cavity portions that are fixed to the flexible resin film so that their center regions overlap with the corresponding cavity portions and their peripheral regions overlap with the first surface of the supporting plate in a plan view; and an air passage capable of introducing outside air into a plurality of sound passages formed by the plurality of cavity portions and the plurality of waveguides, the manufacturing method comprising:
a step of forming a first plate body by preparing a first rigid plate member having a thickness, which is a distance between a first surface on one side and a second surface on the other side in the thickness direction, same as the depth of the plurality of cavity portions, and forming, by etching the first rigid plate member, a plurality of through holes having opening widths same as those of the plurality of cavity portions and penetrating between the first and second surfaces, and also forming, by half-etching the second surface of the first rigid plate member, a first groove having one side opened to an outer side wall of the first rigid plate member and the other side divided into a plurality of branches that are opened to the plurality of through holes, respectively, in a state of opened to the second surface;
a step of forming a second plate body by preparing a second rigid plate member having a thickness, which is a distance between a first surface on one side and a second surface on the other side in the thickness direction, same as the depth of the plurality of waveguides, and forming, by etching the second rigid plate member, a plurality of through holes having opening widths same as those of the plurality of waveguides, and also forming, by half etching the first surface of the second rigid plate member, a second groove having one side opened to an outer side wall of the second rigid plate member and the other side divided into a plurality of branches, in a state of opened to the first surface;
a step of forming the supporting plate by adhering the second surface of the first plate body to the first surface of the second plate body with an adhesive;
a flexible resin film fixing step of fixing the flexible resin film to the supporting plate by an adhesive or by thermocompression bonding so as to cover the plurality of through holes formed in the first plate body; and
a piezoelectric element fixing step of fixing the plurality of piezoelectric elements to the flexible resin film by an insulative adhesive in such a manner that the center regions overlap with the corresponding cavity portions and the peripheral regions overlap with the supporting plate in a plan view,
wherein the first and second grooves that are abutted against each other when the second surface of the first plate body is fixed to the first surface of the second plate body form the air passage.

15. A manufacturing method of an ultrasonic transducer that includes a rigid supporting plate having first and second surfaces on one side and the other side in a thickness direction, respectively and provided with a plurality of waveguides penetrating between the first and second surfaces; a flexible resin film that is fixed to the first surface of the supporting plate so as to cover the plurality of waveguides; the same number of piezoelectric elements as the waveguides that are fixed to the flexible resin film so that their center regions overlap with the corresponding waveguides and their peripheral regions overlap with the first surface of the supporting plate in a plan view; and an air passage capable of introducing outside air into the plurality waveguides, the manufacturing method comprising:
a supporting plate forming step of forming the supporting plate by preparing a rigid plate member having a thickness, which is a distance between a first surface on one side and a second surface on the other side in the thickness direction, same as the depth of the plurality of waveguides, and forming the plurality of waveguides in the rigid plate member by etching and also forming the groove on the first surface of the rigid plate member by half-etching, the groove having one side opened to an outer side wall of the rigid plate member and the other side divided into a plurality of branches that are opened to the plurality of waveguides, respectively, in a state of being opened to the first surface;
a flexible resin film fixing step of fixing the flexible resin film to the first surface of the supporting plate by an adhesive or by thermocompression bonding so as to cover the plurality of waveguides and the groove; and
a piezoelectric element fixing step of fixing the plurality of piezoelectric elements to the flexible resin film by an insulative adhesive in such a manner that the center regions overlap with the corresponding waveguides and the peripheral regions overlap with the supporting plate in a plan view,
wherein the groove and the flexible resin film form the air passage.

16. The manufacturing method of the ultrasonic transducer according to claim 10, further comprising:
a lower sealing plate arranging step of preparing a lower sealing plate having a plurality of piezoelectric-element-directed openings that have a size surrounding the corresponding piezoelectric element and having a thickness greater than the piezoelectric element, and then fixing the lower sealing plate to the flexible resin film by an adhesive so that the plurality of piezoelectric elements are arranged within the plurality of piezoelectric-element-directed openings in a plan view;
a wiring assembly preparation step of preparing a wiring assembly that includes an insulating base layer, a conductor layer arranged on the base layer and an insulating cover layer enclosing the conductor layer, the conductor layer including first and second wirings that are respectively connected to a pair of first and second electrodes of the piezoelectric element, the base layer being formed with first and second wiring/piezoelectric element connection openings for exposing parts of the first and second wirings, respectively;
a wiring assembly fixing step of fixing the base layer to the lower sealing plate by an adhesive; and
an electric connection step of electrically connecting a portion of the first wiring that is exposed through the first wiring/piezoelectric element connection opening and a portion of the second wiring that is exposed through the second wiring/piezoelectric element connection opening to the first and second electrodes of the corresponding piezoelectric element, respectively.
